(19) United States
(12) Patent Application Publication
(10) Pub. No.: US 2022/0198925 A1
(43) Pub. Date: Jun. 23, 2022

(54) TEMPORAL DETECTOR SCAN IMAGE METHOD, SYSTEM, AND MEDIUM FOR TRAFFIC SIGNAL CONTROL

(71) Applicants: Huawei Technologies Canada Co., Ltd., Kanata (CA); The Governing Council of the University of Toronto, Toronto (CA)

(72) Inventors: Soheil MOHAMAD ALIZADEH SHABESTARY, Toronto (CA); Baher ABDULHAI, Mississauga (CA); Hao Hai MA, St. Kleinburg (CA); Scott Patrick SANNER, Scarborough (CA)

(21) Appl. No.: 17/129,646

(22) Filed: Dec. 21, 2020

(51) Int. Cl. G08G 1/01; G06N 3/08; G06K 9/00; G06K 9/62; G08G 1/07

(52) U.S. Cl. CPC G08G 1/0145; G06N 3/08; G08G 1/07; G06K 9/6256; G06K 9/00825; G06K 9/00798

(57) ABSTRACT

Methods, systems, and processor-readable media for generating a temporal detector scan image for traffic signal control are described. An intelligent adaptive cycle-level traffic signal controller uses a deep learning module for traffic signal control, applying image processing techniques to traffic environment data formatted as image data, called “temporal detector scan image” data. A temporal detector scan image is generated by formatting point detector data collected by point detectors (e.g. inductive-loop traffic detectors) over time into two-dimensional matrices representing the traffic environment state in a plurality of lanes over a plurality of points in time, combined with traffic signal data indicating the state of a traffic signal of each lane. The deep learning module may be trained using temporal detector scan image data collected from a traffic environment, and then may be deployed to control the traffic signal for the traffic environment once trained.

### RELATED APPLICATION DATA

This is the first patent application related to this matter.

### FIELD

The present application generally relates methods and systems for traffic signal control, and in particular to methods, systems, and computer-readable media for generating a temporal detector scan image for traffic signal control.

### BACKGROUND

Traffic congestion is responsible for a significant amount of wasted time, wasted fuel, and pollution. Constructing new infrastructure to offset these issues is often not practical due to monetary and space limitations as well as environmental and sustainability concerns. Therefore, in order to increase the capacity of urban transportation networks, researchers have explored the use of technology that maximizes the performance of existing infrastructure. Optimizing the operation of traffic signals has shown promise in decreasing the delays of drivers in urban networks.

A traffic signal is used to communicate traffic rules to drivers of vehicles operating within a traffic environment. A typical traffic signal controller controls a traffic signal managing vehicular traffic at a traffic environment consisting of a single intersection in a traffic network. Thus, for example, a single traffic signal controller may control a traffic signal consisting of red/amber/green traffic lights facing in four directions (North, South, East, and West), although it will be appreciated that some traffic signals may control traffic in environments consisting of more or fewer than four directions of traffic and may include other signal types, e.g., different signals for different lanes facing the same direction, turn arrows, street-based mass transit signals, etc.

A traffic signal typically operates in cycles, each cycle consisting of several phases. A single phase may correspond to a fixed state for the various lights of the traffic signal, for example, green lights facing North and South and red lights facing East and West, or amber lights facing North and South and red lights facing East and West, although some phases may include additional, non-fixed states such as counters counting down for pedestrian crossings. Typically, a traffic signal cycle consists of each phase in the cycle repeated once, typically in a fixed order.

FIG. 1 shows an example traffic signal cycle 100 consisting of eight phases in order from a first phase 102 through an eighth phase 116. In this example, all other lights are red during a phase unless otherwise indicated.

During the first phase 102, Phase 1, the traffic signal displays green left-turn arrows to northbound traffic (i.e. on a south-facing light post), indicated as “NL”, and southbound traffic (i.e. on a north-facing light post), indicated as “SL”. During a second phase 104, Phase 2, the traffic signal displays a green left-turn arrow and a green “through” light or arrow to southbound traffic, indicated as “SL” and “ST” respectively. During a third phase 106, Phase 3, the traffic signal displays a green left-turn arrow and a green “through” light or arrow to northbound traffic, indicated as “NL” and “NT” respectively. During a fourth phase 108, Phase 4, the traffic signal displays an amber left-turn arrow (shown as a broken line) and a green “through” light or arrow to both northbound and southbound traffic. During a fifth phase 110, Phase 5, the traffic signal displays green left-turn arrows to eastbound traffic (i.e. on a west-facing light post), indicated as “EL”, and westbound traffic (i.e. on an east-facing light post), indicated as “WL”. During a sixth phase 112, Phase 6, the traffic signal displays a green left-turn arrow and a green “through” light or arrow to westbound traffic, indicated as “WL” and “WT” respectively. During a seventh phase 114, Phase 7, the traffic signal displays a green left-turn arrow and a green “through” light or arrow to eastbound traffic, indicated as “EL” and “ET” respectively. During the eighth phase 116, Phase 8, the traffic signal displays an amber left-turn arrow (shown as a broken line) and a green “through” light or arrow to both westbound and eastbound traffic.

After completing Phase 8 116, the traffic signal returns to Phase 1 102. Traffic signal controller optimization typically involves optimizing the duration of each phase of the traffic signal cycle to achieve traffic objectives.

The most common approaches for traffic signal control are fixed-time and actuated. In a fixed-time traffic signal controller configuration, each phase of the traffic signal cycle has a fixed duration. Fixed-time controllers use historical traffic data to determine optimal traffic signal patterns; the optimized fixed-time signal patterns (i.e. the set of phase durations for the cycle) are then deployed to control real-life traffic signals, after which time the patterns are fixed and do not change.

In contrast to fixed-time controllers, actuated signal controllers receive feedback from sensors in order to respond to traffic flows; however, they do not explicitly optimize delay, instead typically adjusting signal patterns in response to immediate traffic conditions without adapting to traffic flows over time. Thus, the duration of a phase may be lengthened based on current traffic conditions based on sensor data, but there is no mechanism for using data from past phases or cycles to optimize the traffic signal operation over time, or to base decisions on optimizing a performance metric such as average or aggregate vehicle delay.

Adaptive traffic signal controllers (ATSC) are more advanced and can outperform other controllers, such as fixed-time or actuated controllers. ATSC constantly modify signal timings to optimize a predetermined objective or performance metric such as minimizing delays, stops, fuel consumption, etc. ATSC systems measure the state of the traffic environment (e.g. queue lengths at the approaches to the intersection, traffic approaching from upstream links using GPS and wireless communication, or traffic flows released from upstream intersections) and map the traffic environment state to an optimal action (e.g. which direction to serve, at what time, and for how long), to optimize the performance metric in the long run.

Some ATSCs, including SCOOT, SCATS, PRODYN, OPAC, UTOPIA, and RHODES, optimize the signal using an internal model of a traffic environment that is often simplistic and rarely up-to-date with current conditions. Their optimization algorithms are mostly heuristic and sub-optimal. Due to the stochastic nature of traffic and driver behavior, it is difficult to devise a precise traffic model. The models that are more realistic are also more sophisticated and harder to control, sometimes resulting in computational delays that are too long to enable real-time traffic control. Hence, there is a trade-off between the complexity and practicality of the controller.

There have, however, been some improvements in this area, with the advent of Reinforcement Learning (RL), which is a model-free closed-loop control method used for optimization. RL algorithms can learn an optimal control strategy while interacting with the environment and evaluating their own performance. More recently, researchers have used Deep Reinforcement Learning (DRL) employing Convolutional Neural Networks in an ATSC. Examples of DRL traffic signal control systems are described in W. Genders and S. Razavi, “Using a Deep Reinforcement Learning Agent for Traffic Signal Control,” CoRR, vol. abs/1611.0, 2016; J. Gao, Y. Shen, J. Liu, M. Ito, and N. Shiratori, “Adaptive Traffic Signal Control: Deep Reinforcement Learning Algorithm with Experience Replay and Target Network,” CoRR, vol. abs/1705.0, 2017; and S. M. A. Shabestary and B. Abdulhai, “Deep Learning vs. Discrete Reinforcement Learning for Adaptive Traffic Signal Control,” in 2018 21st International Conference on Intelligent Transportation Systems (ITSC), 2018, pp. 286-293, all of which are hereby incorporated by reference in their entirety. Other AI-based traffic control approaches are described in S. El-Tantawy and B. Abdulhai, “Multi-Agent Reinforcement Learning for Integrated Network of Adaptive Traffic Signal Controllers (MARLIN-ATSC),” Intell. Transp. Syst. (ITSC), 2012 15th Int. IEEE Conf., no. September 2015, pp. 319-326, 2012 (hereinafter “MARLIN”); S. M. A. Shabestary and B. Abdulhai, “Deep Learning vs. Discrete Reinforcement Learning for Adaptive Traffic Signal Control,” in 2018 21st International Conference on Intelligent Transportation Systems (ITSC), 2018, pp. 286-293 (hereinafter “MiND”); H. C. Hu and S. Smith, “Using Bi-Directional Information Exchange to Improve Decentralized Schedule-Driven Traffic Control.” 2019; and H. C. Hu and S. Smith, “Coping with Large Traffic Volumes in Schedule-Driven Traffic Signal Control.” 2019; all of which are hereby incorporated by reference in their entirety.

Existing DRL controllers are designed to take action every second, in what is referred to as second-based control. At each second, the DRL decides either to extend the current green signal or to switch to another phase. It may also be possible to implement a traffic signal controller that generates decision data for an entire cycle, which may be referred to as cycle-based control. A cycle-based controller may produce duration data for all the phases of the next traffic signal cycle.

One approach to discretized action space for traffic signal control is discussed in M. Aslani, M. S. Mesgari, and M. Wiering, “Adaptive traffic signal control with actor-critic methods in a real-world traffic network with different traffic disruption events,” Transp. Res. Part C Emerg. Technol., vol. 85, pp. 732-752, 2017 (hereinafter “Aslani”), which is hereby incorporated by reference in its entirety. Aslani addresses this problem by discretizing the action space into 10-second intervals. So the controller for each phase has to choose a phase duration from the set [0 seconds, 10 seconds, 20 seconds . . . 90 seconds].

Another approach is described in X. Liang, X. Du, G. Wang, and Z. Han, “A Deep Reinforcement Learning Network for Traffic Light Cycle Control,” IEEE Trans. Veh. Technol., vol. 68, no. 2, pp. 1243-1253,2019, hereby incorporated by reference in its entirety, which uses an incremental approach to setting the signal timing. The controller does not define the phase durations directly, but it decides to increase or decrease the timing of each phase by 5 seconds at each decision point.

ATSCs benefit from rich observation of the traffic environment state, which often requires long range detection of traffic queues or measurement of position and speeds of vehicles approaching the traffic light at the intersection well in advance of their arrival the stop bar. For instance, the MARLIN system cited above requires the detection of how long the queues are on all approaches to the intersection. Sometimes those queues can be as long as hundreds of meters (e.g. 300 m from the stop bar at the intersection). The MIND system divides the approaches to the intersection into a grid of cells and requires the measurement of the number of vehicles and their speeds in each cell, as far as possible from the stop bar (e.g. 200-400 m). Such a grid of cells and the values of each cell (e.g., number of vehicles in a cell, average speed of the vehicles in a cell) is analogous to an image with pixel values representing color intensities (e.g., RGB values). This analogy may facilitates the application of methods such as deep learning (e.g. convolutional neural networks and deep Q-learning) to ATSC, by using existing deep learning techniques applied to machine vision or image processing. Such rich “long range” information regarding the state of the traffic environment enhances the ATSC system's ability to find the optimal action that achieves the objective (e.g., minimizing delay). However, not having access to such “long range” information means that the system may be unable to fully observe the state of the traffic environment and its actions may therefore not be optimal.

Such long-range detection, while desirable, is hard to achieve in the field, hence limiting the applicability of theoretically plausible and advanced ATSC systems. Several detection approaches seek to provide such long-range detection, with varying degrees of success, complexity, and cost. Video-based detection, for instance, is typically limited in range to tens of meters (e.g. 50-70 m) from the stop bar, in addition to other challenges such as light and weather conditions. Some radar-based methods are emerging that claim to detect several hundred meters of approaching traffic, but they are relatively costly, adding hundreds of thousands of Canadian dollars of detection cost to every intersection: one such radar-based system is described in “Smartmicro: Intersection Management Radar”, available online at http://www.smartmicro.de/traffic-radar/intersection-management/, which is hereby incorporated by reference in its entirety.

On the other hand, commonly used detectors, such as inductive loop detectors, sense the presence of vehicle traffic at a single point (e.g. one location along the length of a lane of traffic) and hence are unable to provide long range information regarding the state of the traffic environment.

Thus, long range traffic detection remains a challenge.

Some effort have been made to extend information from short range detectors (e.g., inductive loop detectors) to infer the long-range state of traffic environments. Some ATSC systems use traffic models to extend information from point detection to cover a range of space (e.g., the approach to the intersection), such as the SCOOT system described in R. D. Bretherton, K. Wood, and G. T. Bowen, “SCOOT Version 4,” 9th Int. Conf. Road Transp. Inf. Control, no. 454, pp. 104-108, 1998, which is hereby incorporated by reference in its entirety. However, model-free methods such as MIND cannot rely on point detection because they do not provide sufficient traffic environment state information.

There is therefore a need for a long range traffic detection system that overcomes one or more of the limitations of existing approaches identified above.

### SUMMARY

The present disclosure describes methods, systems, and processor-readable media for generating a temporal detector scan image for traffic signal control. An intelligent adaptive cycle-level traffic signal controller is described that uses a deep learning module for traffic signal control. The deep learning module applies image processing techniques to traffic environment data formatted as image data, referred to herein as “temporal detector scan image” data. A temporal detector scan image is generated by formatting point detector data collected by point detectors (e.g. inductive-loop traffic detectors) over time into two-dimensional matrices representing the traffic environment state in a plurality of lanes (a first dimension) over a plurality of points in time (the second dimension). By combining point detector data from multiple locations in each lane with traffic signal data indicating the state of a traffic signal of each lane (e.g., whether the traffic signal for the lane is green, red, or amber at each point in time), the temporal detector scan image provides spatio-temporal traffic state information, formatted as an image for processing by the deep learning module. The deep learning module may be trained using temporal detector scan image data collected from a traffic environment, and then may be deployed to control the traffic signal for the traffic environment once trained. In some embodiments, the point detectors are located and configured such that the temporal detector scan image can be used directly by the deep learning modules to learn the optimal actions for traffic signal control.

Thus, instead of a long range spatial measure of traffic state at single point in time (as in a long range camera or radar-based system), embodiments described herein use a temporal-scan measure at one or more points in space as a surrogate of the hard-to-obtain long range spatial measure of traffic state at a single point in time. The temporal detector scan image may be integrated into a deep learning-based control system to map the traffic environment state representation provided by the temporal detector scan image to the optimal control action that optimizes a performance metric such as average or aggregate vehicle delays or stops, average or aggregate vehicle fuel consumption, etc.

Embodiments described herein may include various deep learning approaches for the deep learning module. Deep reinforcement learning may be used in some embodiments, including Proximal Policy Optimization (PPO) or Deep Q Networks (DQN). In different embodiments, the deep learning module may generate various types for traffic signal control data for controlling the traffic signal, including second-based control data or cycle-based control data.

The use of temporal detector scan image data as input to a deep learning module has a number of potential advantages over existing machine learning-based approaches to adaptive traffic signal control. The point detector data used to generate the temporal detector scan image can be collected using a limited number of point detectors, such as inductive loop traffic detectors or point cameras configured to capture traffic images at close range, thereby potentially reducing cost and complexity, and increasing reliability and robustness, relative to existing approaches using long-range sensors such as radar, lidar, and/or long-range cameras. By using point detectors to generate long range information about the traffic environment, a self-learning adaptive traffic signal control system may be trained and operated in a cost-effective way. The current state of video detection is not sufficient to provide several hundred meters of reliable detection. Other emerging methods such as radar are prohibitively expensive for practical widespread use. In contrast, common detectors such as loop detectors or point cameras provide only detection at a point and hence are insufficient to provide proper spatio-temporal measurement of the state of traffic approaching an intersection. By processing point detector data from a plurality of point detectors at different locations relative to the lanes of a traffic environment, embodiments described herein can furnish a traffic signal controller with an image-like spatio-temporal traffic environment state representation which can be used by the traffic signal controller to learn effective control policies and implement optimal control actions.

As used herein, the term “update” may mean any operation that changes a value or function, or that replaces a value or function with a new value or function.

As used herein, the term “adjust” may mean any operation by which a value, setting, equation, algorithm, or operation is changed. The term “policy”, in the context of reinforcement learning, has the ordinary meaning of that term within the field of machine learning, namely a function (such as a control function) or mathematical formula applied to data inputs to generate an action within an action space. A policy may include parameters whose values are changed when the policy is adjusted.

As used herein, the term “module” refers to one or more software processes executed by a computing hardware component to perform one or more functions.

In some aspects, the present disclosure describes a method for generating a temporal detector scan image for traffic signal control. The method comprises several steps. Temporal traffic state data is obtained, comprising first location traffic data indicating a traffic state at a first location in each of one or more lanes of the traffic environment at each of a plurality of points in time, second location traffic data indicating a traffic state at a second location in each of the one or more lanes at each of the plurality of points in time, and traffic signal data indicating a traffic signal state of each of the one or more lanes at each of the plurality of points in time. A temporal detector scan image is generated by processing the first location traffic data to generate a two-dimensional first location traffic matrix, processing the second location traffic data to generate a two-dimensional second location traffic matrix, and processing the traffic signal data to generate a two-dimensional traffic signal matrix.

In some aspects, the present disclosure describes a system for generating a temporal detector scan image for traffic signal control. The system comprises a processor device and a memory. The memory stores machine-executable instructions thereon. When executed by the processing device, the machine-executable instructions cause the system to perform several steps. Temporal traffic state data is obtained, comprising first location traffic data indicating a traffic state at a first location in each of one or more lanes of the traffic environment at each of a plurality of points in time, second location traffic data indicating a traffic state at a second location in each of the one or more lanes at each of the plurality of points in time, and traffic signal data indicating a traffic signal state of each of the one or more lanes at each of the plurality of points in time. A temporal detector scan image is generated by processing the first location traffic data to generate a two-dimensional first location traffic matrix, processing the second location traffic data to generate a two-dimensional second location traffic matrix, and processing the traffic signal data to generate a two-dimensional traffic signal matrix.

In some examples, the method further comprises providing the temporal detector scan image as input to a deep learning module, and processing the temporal detector scan image using the deep learning module to generate traffic signal control data.

In some examples, the deep learning module comprises a deep reinforcement learning module, and processing the temporal detector scan image comprises using the deep reinforcement learning module to generate traffic signal control data by applying a policy to the temporal detector scan image, the method further comprises: determining an updated state of the traffic environment following application of the traffic signal control data to the traffic signal, generating an updated temporal detector scan image based on the updated state of the traffic environment, generating a reward by applying a reward function to the temporal detector scan image and the updated temporal detector scan image, and adjusting the policy based on the reward.

In some examples, the deep reinforcement learning module comprises a deep Q network, and the traffic signal control data comprises a decision between: extending a current phase of a cycle of the traffic signal, and advancing to a next phase of the cycle of the traffic signal.

In some examples, the deep reinforcement learning module comprises a proximal policy optimization (PPO) module, and the traffic signal control data comprises a phase duration for at least one phase of a cycle of the traffic signal.

In some examples, the method further comprises, for each location of the first locations and second locations, sensing vehicle traffic at the location using a point detector, generating point detector data for the location based on the sensed vehicle traffic, and generating the traffic state data based on the point detector data for each location.

In some examples, each point detector comprises an inductive-loop traffic detector.

In some examples, each point detector comprises a point camera.

In some examples, the traffic environment comprises an intersection, and for each lane of the one or more lanes, the first location and second location in the lane are on the approach to the intersection, and the second location in the lane is closer to the intersection than the first location.

In some examples, the method further comprises, for each location of the first locations and second locations, sensing vehicle traffic at the location using a point detector, generating point detector data for the location based on the sensed vehicle traffic, and generating the traffic state data based on the point detector data for each location. The traffic environment comprises an intersection, and for each lane of the one or more lanes, the first location and second location in the lane are on the approach to the intersection, and the second location in the lane is closer to the intersection than the first location.

In some examples, the memory further stores a deep learning module, and the instructions, when executed by the processing device, further cause the system to provide the temporal detector scan image as input to the deep learning module, and process the temporal detector scan image using the deep learning module to generate traffic signal control data.

In some examples, the deep learning module comprises a deep reinforcement learning module. Processing the temporal detector scan image comprises using the deep reinforcement learning module to generate traffic signal control data by applying a policy to the temporal detector scan image. The instructions, when executed by the processing device, further cause the system to determine an updated state of the traffic environment following application of the traffic signal control data to the traffic signal, generate an updated temporal detector scan image based on the updated state of the traffic environment, generate a reward by applying a reward function to the temporal detector scan image and the updated temporal detector scan image, and adjust the policy based on the reward.

In some examples, the deep reinforcement learning module comprises a deep Q network, and the traffic signal control data comprises a decision between extending a current phase of a cycle of the traffic signal, and advancing to a next phase of the cycle of the traffic signal.

In some examples, the deep reinforcement learning module comprises a proximal policy optimization (PPO) module, and the traffic signal control data comprises a phase duration for at least one phase of a cycle of the traffic signal.

In some examples, the instructions, when executed by the processing device, further cause the system to, for each location of the first locations and second locations, obtain point detector data for the location, and generate the traffic state data based on the point detector data for each location.

In some examples, the system further comprises, for each location of the first locations and second locations, a point detector configured to generate the point detector data based on sensed vehicle traffic at the location.

In some examples, each point detector comprises an inductive-loop traffic detector.

In some examples, each point detector comprises a point camera.

In some aspects, the present disclosure describes a processor-readable medium having a trained reinforcement learning module, trained in accordance with the method steps described above, tangibly stored thereon.

In some aspects, the present disclosure describes a processor-readable medium having instructions tangibly stored thereon. The instructions, when executed by a processor device, cause the processor device to perform the method steps described above.

### BRIEF DESCRIPTION OF THE DRAWINGS

Reference will now be made, by way of example, to the accompanying drawings which show example embodiments of the present application, and in which:

FIG. 1 is a table showing eight phases of an example traffic signal cycle, showing an example operating environment for example embodiments described herein.

FIG. 2 is a block diagram showing an example traffic environment at an intersection, including a traffic signal, in communication with a traffic signal controller in accordance with embodiments described herein.

FIG. 3 is a block diagram of an example traffic signal controller in accordance with embodiments described herein.

FIG. 4 is a flowchart showing steps of an example method for generating a temporal detector scan image for traffic signal control, in accordance with embodiments described herein.

FIG. 5 is a top view of a traffic environment at an intersection, showing the locations of point detectors used to sense vehicle traffic in accordance with embodiments described herein.

FIG. 6 is a schematic diagram of traffic location data and traffic signal data converted into a traffic temporal detector scan image, in accordance with embodiments described herein.

FIG. 7 is a flowchart showing steps of an example method of training a deep reinforcement learning model to generate traffic signal control data in accordance with embodiments described herein.

FIG. 8 is a block diagram of an example deep learning module of a traffic signal controller showing a traffic temporal detector scan image as input and generated traffic signal control data as output, in accordance with embodiments described herein.

Similar reference numerals may have been used in different figures to denote similar components.

### DESCRIPTION OF EXAMPLE EMBODIMENTS

In various examples, the present disclosure describes methods, systems, and processor-readable media for generating a temporal detector scan image for traffic signal control. An intelligent adaptive cycle-level traffic signal controller is described that uses a deep learning module for traffic signal control. The deep learning module applies image processing techniques to temporal detector scan image data.

Various embodiment are described below with reference to the drawings. The description of the example embodiments is broken into multiple sections. The Example Controller Devices section describes example devices or systems suitable for implementing example traffic signal controllers and methods. The Example Deep Learning Modules section describes how the controller learns and updates the parameters of an inference model, such as a deep reinforcement learning model, of the deep learning module. The Example Methods for Generating a Temporal Detector Scan Image for Traffic Signal Control section describes how temporal traffic state data received from point detectors in the traffic environment can be used to generate a temporal detector scan image, which the deep learning module can process using image processing techniques. The Example Training Methods section describes how temporal detector scan images (also called temporal detector scan image data) can be used to train the deep learning module of the controller. The Examples of Traffic Signal Control Data section describes the actions space and outputs of the controller. The Examples of Traffic Environment State Data section describes the state space and inputs of the controller. The Example Reward Functions section describes the reward function of the controller. The Example Systems for Controlling Traffic Signals section describes the operation of the trained controller when it is used to control traffic signals in a real traffic environment.

Example Controller Devices

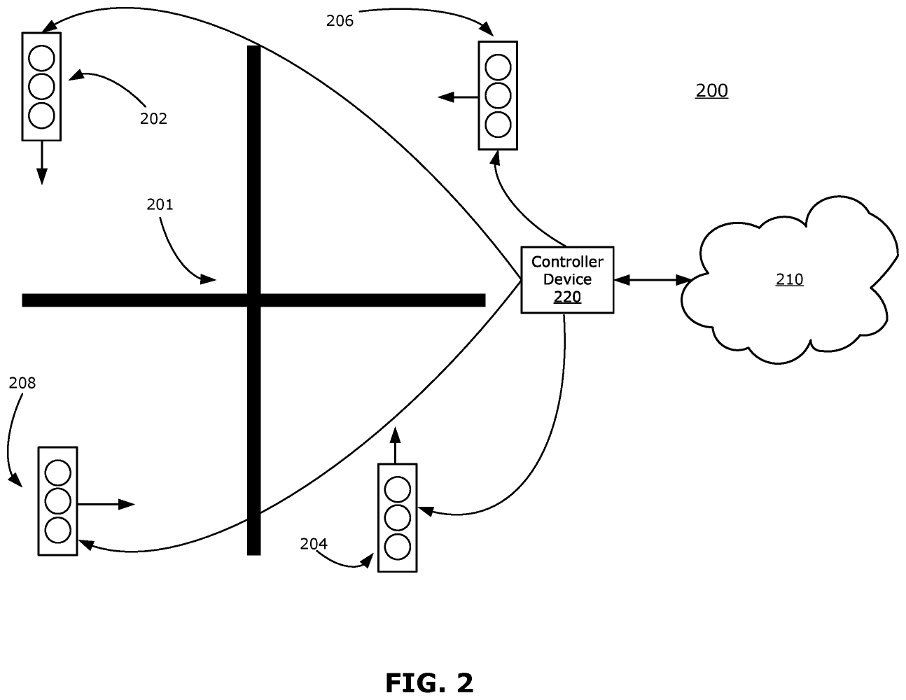

FIG. 2 is a block diagram showing an example traffic environment 200 at an intersection 201, including a traffic signal, in communication with an example traffic signal controller 220. The traffic signal is shown as four traffic lights: a south-facing light 202, a north-facing light 204, an east-facing light 206, and a west-facing light 208. (In all drawings showing top-down views of traffic environments, North corresponds to the top of the page.) The controller device 220 sends control signals to the four traffic lights 202, 204, 206, 208. The controller device 220 is also in communication with a network 210, through which it may communicate with one or more servers or other devices, as described in greater detail below.

It will be appreciated that, whereas embodiments are described herein with reference to a traffic environment consisting of a single intersection managed by a single signal (e.g., a single set of traffic lights), in some embodiments the traffic environment may encompass multiple nodes or intersections within a transportation grid and may control multiple traffic signals.

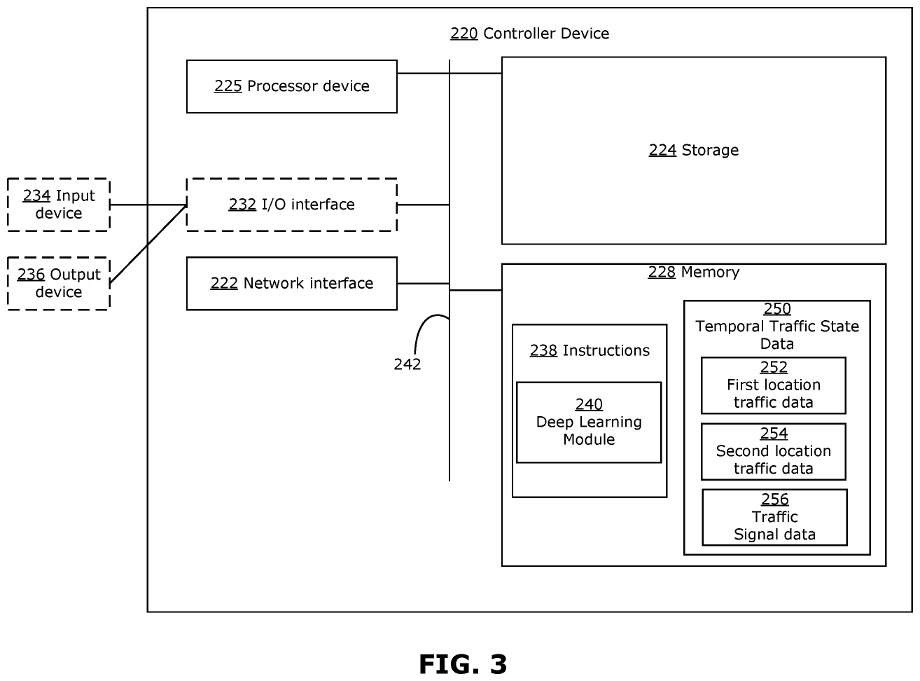

FIG. 3 is a block diagram illustrating a simplified example of a controller device 220, such as a computer or a cloud computing platform, suitable for carrying out examples described herein. Other examples suitable for implementing embodiments described in the present disclosure may be used, which may include components different from those discussed below. Although FIG. 3 shows a single instance of each component, there may be multiple instances of each component in the controller device 220.

The controller device 220 may include one or more processor devices 225, such as a processor, a microprocessor, a digital signal processor, an application-specific integrated circuit (ASIC), a field-programmable gate array (FPGA), a dedicated logic circuitry, a dedicated artificial intelligence processor unit, or combinations thereof. The controller device 220 may also include one or more optional input/output (I/O) interfaces 232, which may enable interfacing with one or more optional input devices 234 and/or optional output devices 236.

In the example shown, the input device(s) 234 (e.g., a maintenance console, a keyboard, a mouse, a microphone, a touchscreen, and/or a keypad) and output device(s) 236 (e.g., a maintenance console, a display, a speaker and/or a printer) are shown as optional and external to the controller device 220. In other examples, there may not be any input device(s) 234 and output device(s) 236, in which case the I/O interface(s) 232 may not be needed.

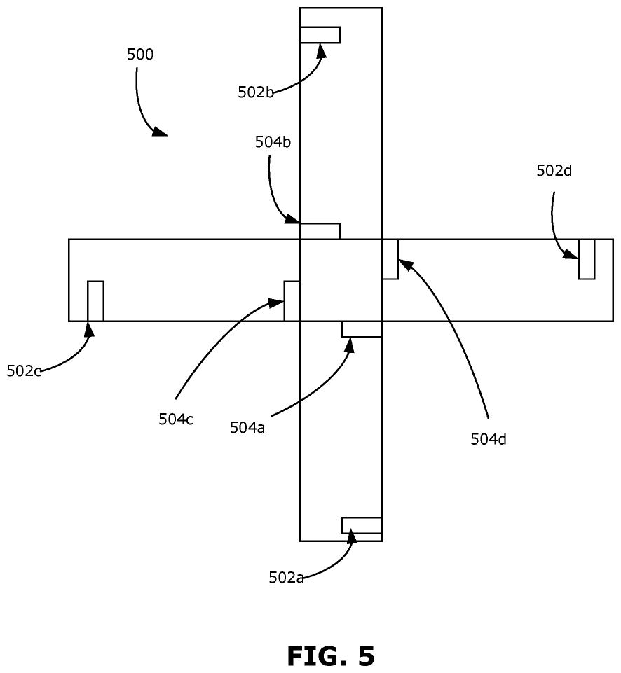

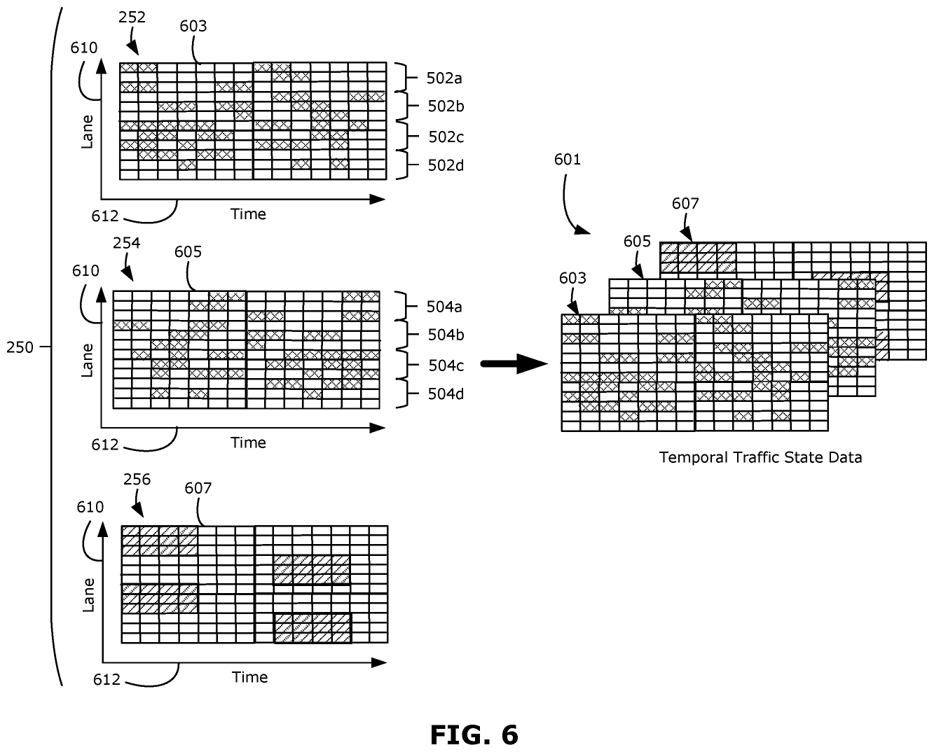

The controller device 220 may include one or more network interfaces 222 for wired or wireless communication with one or more devices or systems of a network, such as network 210. The network interface(s) 222 may include wired links (e.g., Ethernet cable) and/or wireless links (e.g., one or more antennas) for intra-network and/or inter-network communications. One or more of the network interfaces 222 may be used for sending control signals to the traffic signals 202, 204, 206, 208 and/or for receiving data from the point detectors (e.g., point detector data generated by inductive loop traffic detectors, or point cameras or traffic state data based on the point detector data, as described below with reference to FIGS. 5-6). In some embodiments, the traffic signals and/or sensors may communicate with the controller device, directly or indirectly, via other means (such as an I/O interface 232).

The controller device 220 may also include one or more storage units 224, which may include a mass storage unit such as a solid state drive, a hard disk drive, a magnetic disk drive and/or an optical disk drive. The storage units 224 may be used for long-term storage of some or all of the data stored in the memory 228 described below.

The controller device 220 may include one or more memories 228, which may include a volatile or non-volatile memory (e.g., a flash memory, a random access memory (RAM), and/or a read-only memory (ROM)). The non-transitory memory(ies) 228 may store instructions for execution by the processor device(s) 225, such as to carry out examples described in the present disclosure. The memory(ies) 228 may include software instructions 238, such as for implementing an operating system and other applications/functions. In some examples, the memory(ies) 228 may include software instructions 238 for execution by the processor device 225 to implement a deep learning module 240, as described further below. The deep learning module 240 may be loaded into the memory(ies) 228 by executing the instructions 238 using the processor device 225.

In some embodiments, the deep learning module 240 is a deep reinforcement learning module, such as a deep Q network or a PPO module, as described below in the Example Deep Learning Modules section. The deep learning module 240 may be coded in the Python programming language using the tensorflow machine learning library and other widely used libraries, including NumPy. It will be appreciated that other embodiments may use different software libraries and/or different programming languages.

The memor(ies) 228 may also include one or more samples of temporal traffic state data 250, which may be used as training data samples to train the deep learning module 240 and/or as input to the deep learning module 240 for generating traffic signal control data after the deep learning module 240 has been trained and the controller device 220 is deployed to control the traffic signals in a real traffic environment, as described in detail below. The temporal traffic state data 250 may include first location traffic data 252, second location traffic data 254, and traffic signal data 256, as described in detail below with reference to FIGS. 5-6. In some examples, the memory may store temporal traffic state data 250 formatted as one or more temporal detector scan images 601, as described below with reference to FIG. 6.

In some examples, the controller device 220 may additionally or alternatively execute instructions from an external memory (e.g., an external drive in wired or wireless communication with the controller device 220) or may be provided executable instructions by a transitory or non-transitory computer-readable medium. Examples of non-transitory computer readable media include a RAM, a ROM, an erasable programmable ROM (EPROM), an electrically erasable programmable ROM (EEPROM), a flash memory, a CD-ROM, or other portable memory storage.

The controller device 220 may also include a bus 242 providing communication among components of the controller device 220, including those components discussed above. The bus 242 may be any suitable bus architecture including, for example, a memory bus, a peripheral bus or a video bus.

It will be appreciated that various components and operations described herein can be implemented on multiple separate devices or systems in some embodiments.

Example Deep Learning Modules

In some embodiments, a self-learning traffic signal controller interacts with a traffic environment and gradually finds an optimal strategy to apply to traffic signal control. The deep learning module uses deep learning algorithms to train a set of parameters or a policy of a deep learning model to perform traffic signal control. The deep learning module may use any type of deep learning algorithm, including supervised or unsupervised learning algorithms, to train any type of deep learning model, such as a convolutional neural network or other type of artificial neural network.

In some embodiments, the deep learning module (such as deep learning module 240) is a deep reinforcement learning module. The controller (such as controller device 220) generates traffic signal control data by executing the instruction 238 of the deep learning module 240 to apply a function to traffic environment state data (such as temporal traffic state data 250), and using a learned policy of the deep learning module 240 to determine a course of action (i.e. traffic signal control actions in the form of traffic signal control data) based on the output of the function. The function is approximated using a model trained using reinforcement learning, sometimes referred to herein as a “reinforcement learning model” or “RL model”. Thus, in some embodiments, the deep learning module 240 is a deep reinforcement learning module, which uses a reinforcement learning algorithm to train a RL model. The reinforcement learning model may be an artificial neural network, such as a convolutional neural network, in some embodiments. In some embodiments, the traffic environment state data (such as temporal traffic state data 250) may be formatted as one or more two-dimensional matrices, thereby allowing the convolutional neural network or other RL model to apply known image-processing techniques to generate the traffic signal control data.

Formally, the objective of the reinforcement learning model may be stated as follows: given the traffic demand trajectories over time d(t), t∈[0, tₑ]; find a control policy or control function R such that the control variables (e.g. signal phasing) u(t)=R[x(t), t], t∈[0, tₑ], where x(t) is the system state measurements, that minimizes the objective J subject to the system equations and the constraints.

Reinforcement learning (RL) is a technique suitable for optimal control problems that have highly complicated dynamics. These problems may be difficult to model, difficult to control, or both. In RL, the controller can be functionally represented as an agent having no knowledge of the environment that it is working on. In early stages of training, the agent starts taking random actions, called exploration. For each action, the agent observes the changes in the environment (e.g., through sensors monitoring a real traffic environment, or through receiving simulated traffic environment from a simulator), and it also receives a numerical value called a reward, which indicates a degree of desirability of its actions. The objective of the agent is to optimize the cumulative reward over time, not the immediate reward it receives after any given action. This optimization of cumulative reward is necessary in domains such as traffic signal control, in which the actions of the agent affect the future state of the system, requiring the agent to consider the future consequences of its actions beyond their immediate impact. As training progresses, the agent starts learning about the environment and takes fewer random actions; instead, it takes actions that, based on its experience, lead to better performance of the system.

In some embodiments, an actor-critic reinforcement learning model is used by the controller. In particular, a Proximal Policy Optimization (PPO) module, including a PPO model trained using PPO, may be used as the deep learning module 240 in some embodiments. A PPO model is a variation of a deep actor-critic RL model. Actor-critic RL models can generate continuous action values (e.g., traffic signal cycle phase durations) as output. An actor-critic RL model has two parts: an actor, which defines the policy of the agent, and a critic, which helps the actor to optimize its policy during training.

A PPO model of a PPO module may be particularly suited for use as the RL model of the deep learning module 240 in embodiments using cycle-based traffic signal control. Some embodiments may generate traffic signal control data for controlling the duration and timing of one or more phases of a cycle of the traffic signal; other embodiments may generate traffic signal control data for controlling the duration and timing of each phase of one or more complete cycles of the traffic signal. A PPO module may thus be used in some embodiments to generate traffic signal control data comprising a phase duration for at least one phase of a cycle of the traffic signal.

In other embodiments, a deep Q network may be used by the deep learning module 240. Deep Q networks may be particularly suited for use as the RL model of the deep learning module 240 in embodiments using second-based traffic signal control. Thus, in some embodiments a deep Q network may be used to generate traffic signal control data comprising a decision between extending a current phase of a cycle of the traffic signal, and advancing to a next phase of the cycle of the traffic signal.

Example Methods for Generating a Temporal Detector Scan Image for Traffic Signal Control

As described above, traffic signal control may be facilitated by the generation of a temporal detector scan image, which may be used as input to a deep learning module to generate traffic signal control data. Example methods will now be described for generating a temporal detector scan image, including optional steps for obtaining the point detector data used to generate the temporal detector scan image and optional steps for using the temporal detector scan image to train a deep reinforcement learning model of the deep learning module.

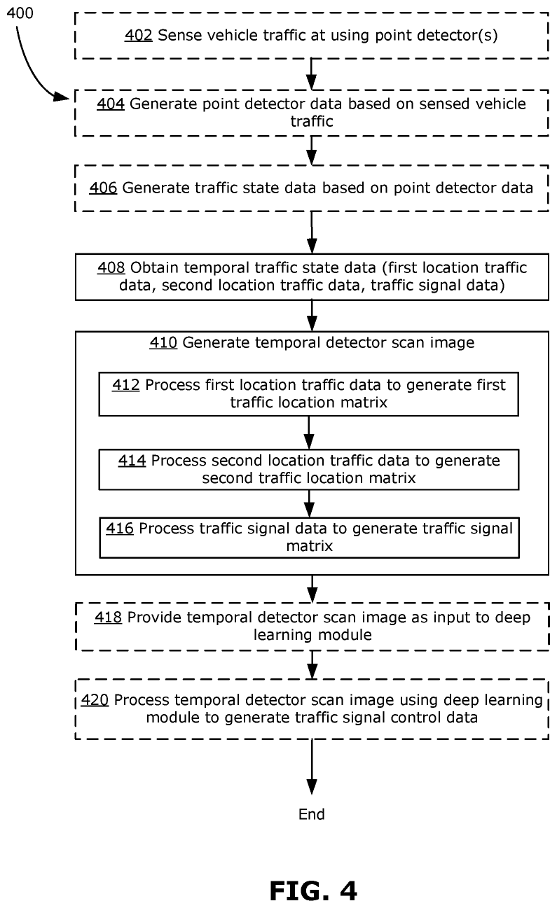

FIG. 4 shows an example method 400 of generating a temporal detector scan image for traffic signal control. In some embodiments, the temporal detector scan image generation steps of the method 400 are performed by a controller device or system, such as the controller device 220. In other embodiments, the temporal detector scan image may be generated by another device and provided to the controller. Other steps of the method 400 may be performed by the controller or by another device or other devices, as described below.

Steps 402 through 406 are optional. In these steps, point detectors located in a traffic environment are used to collect vehicle traffic data and transform that data into traffic data usable by the controller to generate the temporal detector scan image. Steps 402 through 406 may be performed by the controller (such as controller device 220), by hardware controllers of one or more point detectors, by a point detector network controller device, or by some combination thereof.

FIG. 5 shows a top view of a traffic environment 500 at an intersection, showing the locations of point detectors used to sense vehicle traffic. The intersection has four approaches. Each approach can be as long as the full length of the road link all the way to an upstream intersection. Each point detector is positioned and configured to detect the presence of vehicles at a particular location along the length of one or more lanes of traffic. In some embodiments, the point detectors may be inductive loop traffic detectors, also called vehicle detection loops, configured to sense the presence of large metal vehicles using an electric current induced in a conductive loop of material laid across or embedded in a road surface. An inductive loop traffic detector may be used to detect a vehicle in a single lane, or it may be laid across several lanes to detect a vehicle in any of the lanes it traverses. In some embodiments, the point detectors may be point cameras. Each point camera operates to capture images of vehicles occupying a longitudinal location along the length of one or more traffic lanes. Machine vision techniques may be used to process the image data captured by the point cameras to recognize the presence or absence of vehicles. Some point cameras may be positioned and configured to detect the presence of vehicles in a single lane; others may be positioned and configured to detect the presence of vehicles in each of two or more lanes along a single line or stripe crossing the two or more lanes. Thus, each point detector can detect the presence or absence of vehicle traffic in one or more lanes of traffic, but this detection is limited to a single point or small area along the length of the traffic lane(s). It will be appreciated that other technologies, such as electric eyes, weight sensors, or photoreceptors may be used to achieve similar detection of vehicles at a highly localized area in a lane, or a plurality of adjacent lanes, of traffic. Some embodiments may use multiple different types of point detectors to sense vehicle traffic in different lanes or at different locations.

Eight point detectors are shown in FIG. 5. A first set of point detectors are positioned and configured to sense vehicle traffic at a first location in each of one or more lanes of the traffic environment 500: first northbound point detector 502a senses traffic at a first location in the northbound lanes approaching the intersection, first southbound point detector 502b senses traffic at a first location in the southbound lanes approaching the intersection, first eastbound point detector 502c senses traffic at a first location in the eastbound lanes approaching the intersection, and first westbound point detector 502d senses traffic at a first location in the westbound lanes approaching the intersection. In each direction, the first location is located on the approach to the intersection and distal from the intersection. For example, in some embodiments the first location may be 50 meters from the stop bar of the intersection. In other embodiments, the first location may be a different distance from the intersection in different lanes and/or in different traffic directions.

A second set of point detectors are positioned and configured to sense vehicle traffic at a second location in each of one or more lanes of the traffic environment 500: second northbound point detector 504a senses traffic at a second location in the northbound lanes approaching the intersection, second southbound point detector 502b senses traffic at a second location in the southbound lanes approaching the intersection, second eastbound point detector 502c senses traffic at a second location in the eastbound lanes approaching the intersection, and second westbound point detector 502d senses traffic at a second location in the westbound lanes approaching the intersection. In each direction, the second location is located on the approach to the intersection and closer to the intersection than to the first location. In some embodiments, the second location is at or near the stop bar of the intersection.

Each of the four traffic directions (north, south, east, west) shown in FIG. 5 may include one or more road lanes configured to carry traffic in that direction. Each point detector shown in FIG. 5 may monitor one or more lanes, and in some embodiments there may be multiple individual point detectors positioned at each point detector location (i.e. each first location and each second location), e.g., one point detector to monitor each lane at each location. Thus, in one example embodiment the traffic environment 500 may include three southbound lanes to the north of the intersection, and there may be one individual point detector (e.g., an inductive loop traffic detector) located at the first location (i.e. the location of first southbound point detector 502b) in each of the three southbound lanes, for a total of three inductive-loop traffic detectors at the location of first southbound point detector 502b.

Returning to FIG. 4, at 402, each point detector (e.g., point detectors 502a-d at each first location and point detectors 504a-d at each second location) senses vehicle traffic at its respective location. Sensing vehicle traffic may include sensing the presence of a vehicle in a single lane being monitored by a point detector, or sensing the presence of at least one vehicle in one of multiple lanes being monitored by a point detector.

At 404, for each location of the first locations and second locations, the point detectors (e.g., point detectors 502a-d and 504a-d) generate point detector data for the location based on the sensed vehicle traffic. In some embodiments, the point detector data may be simply a binary indication of the presence or absence of a vehicle at the location at a point in time. In other embodiments, the point detector data may encode information regarding the sensed vehicle traffic over a period of time. For example, in some embodiments, the point detector data may encode the number of vehicles passing through the location over a time period, such as one second or ten seconds. The number of vehicles passing through the location may be determined in some embodiments by identifying a pattern of vehicle presence and vehicle absence corresponding to a number of vehicles passing through the location. In some embodiments, each point detector includes a point detector controller (e.g., a microcontroller or other data processing device) configured to generate the point detector data. In some embodiments, the point detector data is generated by a single point detector controller in communication with multiple point detectors. In some embodiments, the point detectors may provide raw sensor data to the traffic signal controller (e.g., to controller device 220 via the network interface 222), which generates the point detector data (e.g., using the processor device 225).

At 406, traffic state data is generated based on the point detector data for each location. As at step 404, the traffic state data may be generated, e.g., by a point detector controller at each point detector, by a single point detector controller in communication with multiple point detectors, or by the traffic signal controller. In some embodiments, the traffic state data indicates vehicle traffic data for each location for each of a plurality of time periods. In some embodiments, the vehicle traffic data for each location for each time period is a binary value indicating the presence or absence of a vehicle at the location during the rime period. In some embodiments, the vehicle traffic data for each location for each time period is a numerical value indicating the number of vehicles passing through the location during the time period. In some embodiments, the traffic state data indicates vehicle traffic data for each location for a single time period or for a single point in time. It will be appreciated that other configurations for the vehicle traffic data are possible.

Step 408 through 416 may be referred to as the “temporal detector scan image generation” steps, and may be performed by the traffic signal controller (e.g., controller device 220) in some embodiments.

At 408, temporal traffic state data is obtained. The temporal traffic state data includes first location traffic data, second location traffic data, and traffic signal data. The first location traffic data indicates a traffic state at a first location in each of one or more lanes of the traffic environment at each of a plurality of points in time. The second location traffic data indicates a traffic state at a second location in each of the one or more lanes at each of the plurality of points in time. The traffic signal data indicates a traffic signal state of each of the one or more lanes at each of the plurality of points in time.

In some embodiments, the controller device 220 performs step 408 by receiving the first location traffic data and second location traffic data from the one or more point detector controllers as described at steps 404-406 above. As described at step 406, in some embodiments the first location traffic data and second location traffic data may be received over time as traffic state data indicating traffic state at each location for a single point in time or period of time. The traffic state data for each location may be compiled by the controller device 220 into first location traffic data and second location traffic data for a plurality of points in time or periods of time. In other embodiments, the point detector controllers may compile traffic state data for multiple points in time or periods of time and transmit the compiled data to the controller device 220.

In an example embodiment, the point detector controllers generate point detector data by sampling each point detector once per second. The point detector data for each point detector for a given sample period (i.e. one second) consists of a binary indication of whether a vehicle is present at the time the sample is obtained (e.g., 1 for the presence of a vehicle, 0 for the absence of a vehicle). The traffic state data may consist of the samples from each point detector in the traffic environment 500 for a single sample period. The point detector controller(s) transmit the traffic state data to the traffic signal controller (e.g. controller device 220) at each sample period.

The traffic signal data may be obtained from the traffic controller itself. In some embodiments, as shown in FIG. 2, the controller device 220 is used to control the state of the traffic signal and thus has direct access to the state of the traffic signal for each lane (e.g., the state of each directional traffic light 202, 204, 206, 208).

At step 410, a temporal detector scan image is generated based on the temporal traffic state data. Step 410 may include sub-steps 412, 414, and 416. At 412, the first location traffic data is processed to generate a two-dimensional first location traffic matrix. At 414, the second location traffic data is processed to generate a two-dimensional second location traffic matrix. At 416, the traffic signal data is processed to generate a two-dimensional traffic signal matrix. Step 410 and sub-steps 412 through 416 will be described with reference to FIG. 6.

FIG. 6 shows an example schematic diagram of temporal traffic state data 250 converted into a temporal detector scan image 601. The temporal traffic state data 250 includes first location traffic data 252, second location traffic data 254, and traffic signal data 256. In the illustrated example, the first location traffic data 252, second location traffic data 254, and traffic signal data 256 are shown as two-dimensional matrices.

The first location traffic data 252 is shown as a first location traffic matrix 603 consisting of data elements arranged along a Y axis 610 representing a plurality of traffic lanes monitored by the point detectors, and an X axis 612 representing time, e.g., a plurality of points in time or periods of time (e.g., a one-second period each). Each element of the first location traffic matrix 603 represents the traffic state (e.g., number of vehicles passing through during the time period) of the first location in each of the plurality of lanes at each time (e.g., point in time or period of time). Thus, the first location traffic matrix 603 may be generated based on data obtained from the point detectors at the first locations 502a-d.

Similarly, the second location traffic data 254 is shown as a second location traffic matrix 605 consisting of data elements arranged along a Y axis 610 representing a plurality of traffic lanes monitored by the point detectors, and an X axis 612 representing time. Each element of the second location traffic matrix 605 represents the traffic state of the second location in each of the plurality of lanes at each time. Thus, the second location traffic matrix 605 may be generated based on data obtained from the point detectors at the second locations 504a-d.

The traffic signal data 256 is shown as a traffic signal matrix 607 consisting of data elements arranged along a Y axis 610 representing a plurality of traffic lanes monitored by the point detectors, and an X axis 612 representing time. Each element of the traffic signal matrix 607 represents the traffic signal state of each of the plurality of lanes at each time. In some embodiments, the value of each element may be a first value indicating a green light traffic signal state for that lane or a second value indicating an amber or red light traffic signal state for that lane. Other embodiments may use further values to distinguish amber from red, and/or further values to distinguish advance green turn arrows from regular green lights.

The traffic temporal detector scan image 601 is generated at step 410 by arranging, concatenating, or otherwise combining the three matrices 603, 605, 607 into a single three-channel image, wherein each element of each matrix is analogous to a pixel value of the image. The traffic temporal detector scan image 601 may be used as input to a deep learning module (e.g., deep learning module 240), which may process the traffic temporal detector scan image 601 using image processing techniques used in deep learning to generate traffic signal control data, as described in detail below in the Example Traffic Signal Control Data section.

Whereas FIG. 6 shows the temporal traffic state data 250 already formatted as matrices 603, 605, 607, it will be appreciated that in some embodiments the temporal traffic state data 250 will have another format, and may be formatted as matrices 603, 605, 607 by sub-steps 412, 414, and 416 respectively. More generally, it will be appreciated that in some embodiments one or more of the described data entities (e.g., point detector data, traffic state data, and/or temporal traffic state data 250) may have a format equivalent to the format of a predecessor data entity (e.g., the traffic state data may be equivalent to the point detector data in some embodiments), and thus the step of generating the downstream data entity (e.g., the traffic state data) may be performed trivially.

Returning to FIG. 4, optional steps 418 and 420 may be performed by the traffic signal controller (e.g., controller device 220) to operate a deep learning module (e.g., deep learning module 240) to generate traffic signal control data by using the temporal detector scan image 601 as input.

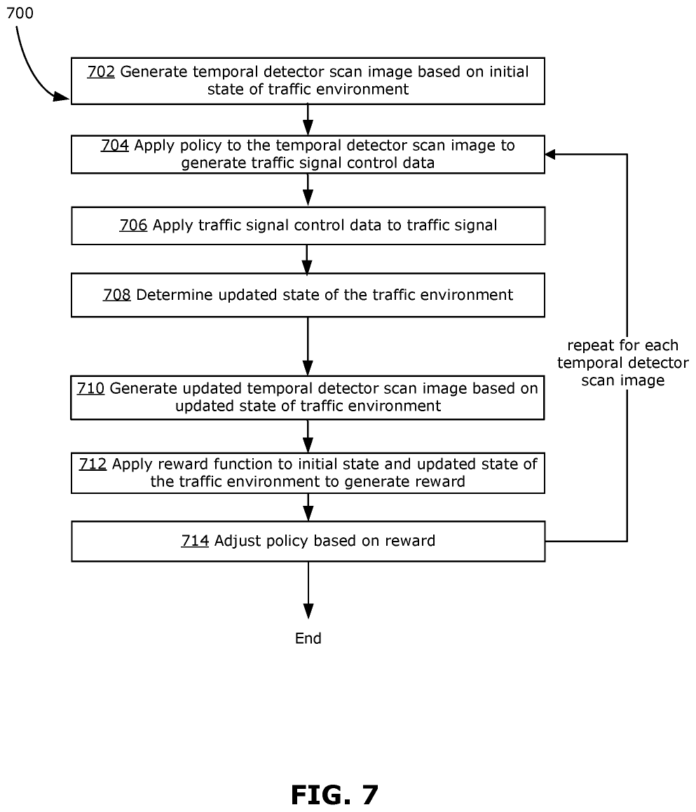

At 418, the temporal detector scan image 601 is provided as input to the deep learning module 240. This step 418 may include known deep learning techniques for preprocessing image data used as input to a deep learning model. In some examples, the temporal detector scan image 601 may be used as training data to train the deep learning model of the deep learning module 240, as described in greater detail in reference to FIG. 7 below. In other examples, the temporal detector scan image 601 may be used as input to a trained deep learning module (e.g., trained using the method 700 described below with reference to FIG. 7) deployed to operate in an inference mode to control a traffic signal used by a real traffic environment.

At 420, the temporal detector scan image 601 is processed using the deep learning module 240 to generate traffic signal control data, as described in greater detail below in the Example Traffic Signal Control Data section.

Example Training Methods

The deep learning module 240 used by the controller device 220 must be trained before it can be deployed for effecting control of a traffic signal in a traffic environment. In embodiments using a deep reinforcement learning module, training is carried out by supplying traffic environment data (such as temporal traffic state data 250, described in the previous section) to the deep reinforcement learning module, using the traffic signal control data generated by the deep reinforcement learning module to control the traffic signals in the traffic environment, then supplying traffic environment data representing the updated state of the traffic environment data (such as an updated version of the temporal traffic state data 250) to the deep RL model for use in adjusting the deep RL model policy and for generating future traffic signal control data.

FIG. 7 shows an example method 700 of training a deep reinforcement learning model to generate traffic signal control data.

At 702, a temporal detector scan image 601 is generated based on an initial state of the traffic environment 500. This step 702 may be performed by steps 408 and 410 (and optionally steps 402 through 406) of method 400 described in the previous section.

At 704, upon receiving the temporal detector scan image 601, the RL model applies its policy to the temporal detector scan image 601 and optionally one or more past temporal detector scan images to generate traffic signal control data, as described in greater detail in the Example Traffic Signal Control Data section below.

At 706, the traffic signal control data is applied to a real or simulated traffic signal. In the case of a real traffic environment using real traffic signals, the controller device 220 may send control signals to the traffic signal (e.g., lights 202, 204, 206, 208) to effect the decisions dictated by the traffic signal control data. In the case of a simulated traffic environment, the RL model provides the traffic signal control data to a simulator module, which simulates a response of the traffic environment to the traffic signal control decisions dictated by the traffic signal control data.

At 708, an updated state of the real or simulated traffic environment is determined. The updated traffic state may be represented in some embodiments by updated temporal traffic state data 250 as described above with reference to FIG. 6. The updated temporal traffic state data 250 may include data elements corresponding to times (e.g., along X axis 612) that are subsequent to the point in time at which the traffic signal decision of step 706 was applied to the traffic signal of the traffic environment.

At 710, a new temporal detector scan image 601 is generated based on the updated state of the traffic environment determined at step 708. In some embodiments, step 710 may be performed by the controller device 220 by performing steps 408 and 410 (and optionally steps 402 through 406) of method 400 described above.

At 712, a reward function of the deep RL module is applied to the initial state of the traffic environment and the updated state of the traffic environment to generate a reward value.

At 714, the deep RL module adjusts its policy based on the reward generated at step 712. The weights or parameters of the deep RL model may be adjusted using RL techniques, such as PPO actor-critic or DQN deep reinforcement learning techniques.

The method 700 then returns to step 704 to repeat the step 704 of processing a temporal detector scan image 601, the temporal detector scan image 601 (generated at step 710) now indicating the updated state of the traffic environment (determined at step 708). This loop may be repeated one or more times (typically at least hundreds or thousands of times) to continue training the RL model.

Thus, method 700 may be used to train the RL model and update the parameters of its policy, in accordance with known reinforcement learning techniques using image data as input.

Examples of Traffic Signal Control Data

The deep learning module 240 processes the temporal detector scan image 601 used as input to generate traffic signal control data. The traffic signal control data may be used to make decisions regarding the control (i.e. actuation) of the traffic signal. The action space used by the deep learning module 240 in generating the traffic signal control data may be a continuous action space, such as a natural number space, or a discrete action space, such as a decision between extending a traffic signal phase for one second or advancing to the next traffic signal phase.

Some embodiments generate traffic signal control data comprising a phase duration for at least one phase of a cycle of the traffic signal. The traffic signal control data may thus be one or more phase durations of one or more respective phases of a traffic signal cycle. In some embodiments, each phase duration is a value selected from a continuous range of values. This selection of a phase duration from a continuous range of values may be enabled in some examples by the use of an actor-critic RL model, as described in detail above.

In some embodiments, the traffic signal control data includes phase durations for each phase of at least one cycle of the traffic signal. In other embodiments, the traffic signal control data includes a phase duration for only one phase of a cycle of the traffic signal. Cycle-level control and phase-level control may present trade-offs between granularity and predictability.

Embodiments operating at cycle-level or phase-level control of the traffic signal may have relatively low frequency interaction with the traffic signal relative to second-level controllers: a cycle-level controller may send control signals to the traffic signal once per cycle, for example at the beginning of the cycle, whereas a phase-level controller may send control signals to the traffic signal once per phase, for example at the beginning of the phase.

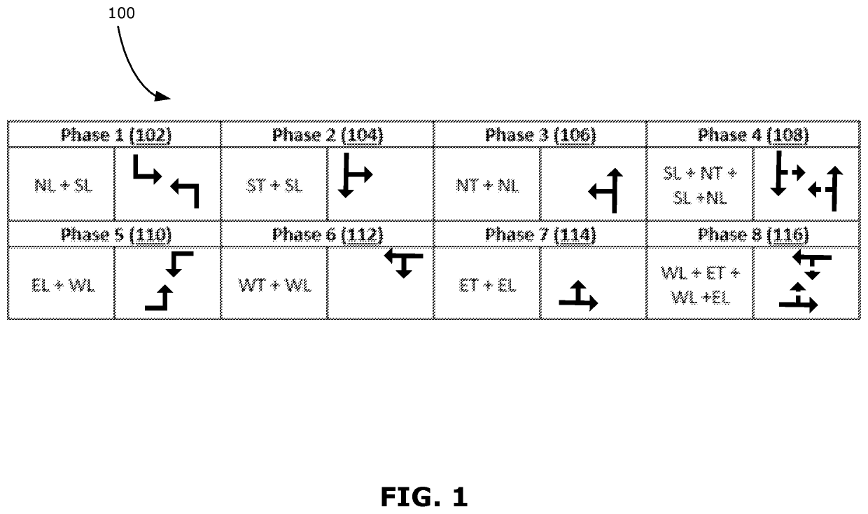

In some embodiments, phase-level or cycle-level control may be constrained to a fixed sequence of phases (e.g., the eight sequential phases 102 through 116 shown in FIG. 1), but may dictate durations for the phases. In other embodiments, one or more of the phases in the sequence may be omitted, or the sequence of phases may be otherwise reordered or modified. Constraining the sequence of phases may have advantages in terms of conforming to driver expectations, at the cost of potentially sacrificing some flexibility and therefore potentially some efficiency.

Thus, for a traffic signal having P phases per cycle (e.g., P=8 in the example of FIG. 1), the output of a deep learning module 240 using cycle-level control may be P natural numbers, each indicating the length of a traffic signal phase. A deep learning module 240 using phase-level control may generate only one natural number indicating the length of a traffic signal phase. Other embodiments may generate different numbers of phase durations.

In some embodiments, the phase durations generated by the deep learning module 240 are selected from a different continuous range, such as positive real numbers. The use of an actor-critic RL model (such as a PPO model) may enable the generation of phase durations selected from a continuous range of values, rather than a limited number of discrete values (such as 5-second or 10-second intervals as in existing approaches).

Other embodiments generate traffic signal control data comprising a decision between extending a current phase of a cycle of the traffic signal, and advancing to a next phase of the cycle of the traffic signal. This decision may be implemented on a per-time-period (e.g. per-second) basis. In a second-based control approach with a fixed order of phases in each cycle, the controller has to decide either to extend the current green phase or to switch to next phase, which leads to a discrete action space of size two (e.g., 0=extend, 1=switch). In some embodiments, second-based control may also include flexible ordering of phases within each cycle, as described above with reference to cycle-based or phase-based control.

As described above, a PPO deep reinforcement learning module may be particularly suitable for cycle-based on phase-based control, whereas a DQN deep reinforcement learning module may be particularly suitable for second-based control.

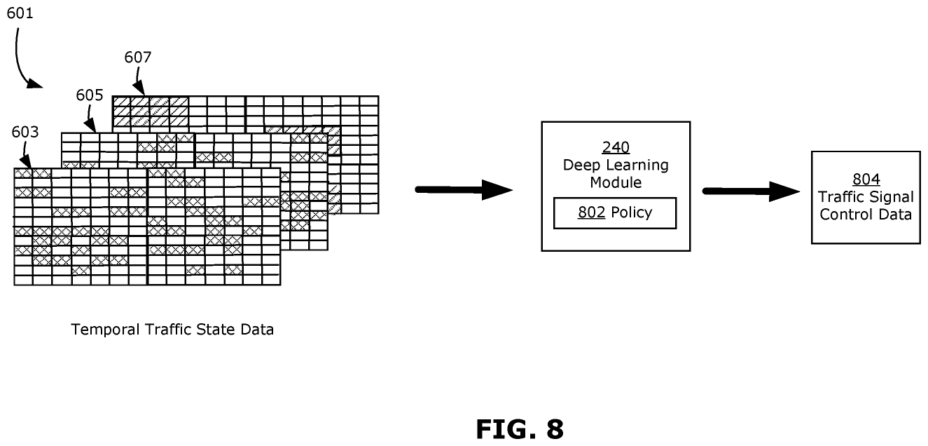

FIG. 8 shows a block diagram of an example deep learning module 240 of a traffic signal controller (e.g., controller device 220) showing a traffic temporal detector scan image 601 as input and generated traffic signal control data 804 as output. The traffic signal control data 804 may be, e.g., cycle-based, phase-based, or second-based traffic signal control data, as described above. The deep learning module 240 is shown using a policy 802 to generate the traffic signal control data 804, as described above with reference to step 704 of method 700.

Example Reward Functions

Different embodiments may use different reward functions. A reward function may be based on a traffic flow metric or performance metric intended to achieve certain optimal outcomes. As described above, various embodiments may use different performance metrics, such as total throughput (the number of vehicles passing through the intersection per cycle), the longest single delay for a single vehicle over one or more cycles, or any other suitable metric, to determine reward.

Example Systems for Controlling Traffic Signals

Once the deep learning model has been trained as described above, the controller device 220 may be deployed for use in controlling a real traffic signal in a real traffic environment. When deployed for the purpose of controlling a real traffic signal, the deep learning module 240 and other components described above operate much as described with reference to the training method 700. When deployed to control a real traffic signal, the controller device 220 may make up all or part of a system for controlling a traffic signal, and in particular a system for generating a temporal detector scan image for traffic signal control. The controller device 220 includes the components described with reference to FIG. 3, including the processor device 225 and memory 228. The deep learning module 240 stored in the memory 228 now includes a trained deep learning model, which has been trained in accordance with one or more of the techniques described above. The traffic environment used to train the reinforcement learning model is the same real traffic environment now being controlled, or a simulated version thereof. The instructions 238, when executed by the processor device 225, cause the system to carry out steps of method 700, and in particular steps 702 through 710. In some embodiments, the system continues to train the RL model during deployment by also performing steps 712 and 714.

It will be appreciated that, in some embodiments, a system for traffic signal control may also include one or more of the other components described above, such as one or more of the point detectors 502a-d and 504a-d, one or more point detector controllers (included in, or separate from, each point detector), and/or one or more of the traffic lights 202, 204, 206, 208.

General

Although the present disclosure describes methods and processes with steps in a certain order, one or more steps of the methods and processes may be omitted or altered as appropriate. One or more steps may take place in an order other than that in which they are described, as appropriate.

Although the present disclosure is described, at least in part, in terms of methods, a person of ordinary skill in the art will understand that the present disclosure is also directed to the various components for performing at least some of the aspects and features of the described methods, be it by way of hardware components, software or any combination of the two. Accordingly, the technical solution of the present disclosure may be embodied in the form of a software product. A suitable software product may be stored in a pre-recorded storage device or other similar non-volatile or non-transitory computer readable medium, including DVDs, CD-ROMs, USB flash disk, a removable hard disk, or other storage media, for example. The software product includes instructions tangibly stored thereon that enable a processing device (e.g., a personal computer, a server, or a network device) to execute examples of the methods disclosed herein.

The present disclosure may be embodied in other specific forms without departing from the subject matter of the claims. The described example embodiments are to be considered in all respects as being only illustrative and not restrictive. Selected features from one or more of the above-described embodiments may be combined to create alternative embodiments not explicitly described, features suitable for such combinations being understood within the scope of this disclosure.

All values and sub-ranges within disclosed ranges are also disclosed. Also, although the systems, devices and processes disclosed and shown herein may comprise a specific number of elements/components, the systems, devices and assemblies could be modified to include additional or fewer of such elements/components. For example, although any of the elements/components disclosed may be referenced as being singular, the embodiments disclosed herein could be modified to include a plurality of such elements/components. The subject matter described herein intends to cover and embrace all suitable changes in technology.

1. A method for generating a temporal detector scan image for traffic signal control, the method comprising:
obtaining temporal traffic state data comprising:
first location traffic data indicating a traffic state at a first location in each of one or more lanes of the traffic environment at each of a plurality of points in time;
second location traffic data indicating a traffic state at a second location in each of the one or more lanes at each of the plurality of points in time; and
traffic signal data indicating a traffic signal state of each of the one or more lanes at each of the plurality of points in time; and
generating a temporal detector scan image by:
processing the first location traffic data to generate a two-dimensional first location traffic matrix;
processing the second location traffic data to generate a two-dimensional second location traffic matrix; and
processing the traffic signal data to generate a two-dimensional traffic signal matrix.

2. The method of claim 1, further comprising:
providing the temporal detector scan image as input to a deep learning module; and
processing the temporal detector scan image using the deep learning module to generate traffic signal control data.

3. The method of claim 2, wherein:
the deep learning module comprises a deep reinforcement learning module; and
processing the temporal detector scan image comprises using the deep reinforcement learning module to generate traffic signal control data by applying a policy to the temporal detector scan image,
the method further comprises:
determining an updated state of the traffic environment following application of the traffic signal control data to the traffic signal;
generating an updated temporal detector scan image based on the updated state of the traffic environment;
generating a reward by applying a reward function to the temporal detector scan image and the updated temporal detector scan image; and
adjusting the policy based on the reward.

4. The method of claim 3, wherein:
the deep reinforcement learning module comprises a deep Q network; and
the traffic signal control data comprises a decision between:
extending a current phase of a cycle of the traffic signal; and
advancing to a next phase of the cycle of the traffic signal.

5. The method of claim 3, wherein:
the deep reinforcement learning module comprises a proximal policy optimization (PPO) module; and
the traffic signal control data comprises a phase duration for at least one phase of a cycle of the traffic signal.

6. The method of claim 1, further comprising, for each location of the first locations and second locations:
sensing vehicle traffic at the location using a point detector;
generating point detector data for the location based on the sensed vehicle traffic; and
generating the traffic state data based on the point detector data for each location.

7. The method of claim 6, wherein each point detector comprises an inductive-loop traffic detector.

8. The method of claim 6, wherein each point detector comprises a point camera.

9. The method of claim 1, wherein:
the traffic environment comprises an intersection; and
for each lane of the one or more lanes:
the first location and second location in the lane are on the approach to the intersection; and
the second location in the lane is closer to the intersection than the first location.

10. The method of claim 3,
further comprising, for each location of the first locations and second locations:
sensing vehicle traffic at the location using a point detector;
generating point detector data for the location based on the sensed vehicle traffic; and
generating the traffic state data based on the point detector data for each location,
wherein:
the traffic environment comprises an intersection; and
for each lane of the one or more lanes:
the first location and second location in the lane are on the approach to the intersection; and
the second location in the lane is closer to the intersection than the first location.

11. A system for generating a temporal detector scan image for traffic signal control, comprising:
a processor device; and
a memory storing:
machine-executable instructions thereon which, when executed by the processing device, cause the system to:
obtain temporal traffic state data comprising:
first location traffic data indicating a traffic state at a first location in each of one or more lanes of the traffic environment at each of a plurality of points in time;
second location traffic data indicating a traffic state at a second location in each of the one or more lanes at each of the plurality of points in time; and
traffic signal data indicating a traffic signal state of each of the one or more lanes at each of the plurality of points in time; and
generate a temporal detector scan image by:
processing the first location traffic data to generate a two-dimensional first location traffic matrix;
processing the second location traffic data to generate a two-dimensional second location traffic matrix; and
processing the traffic signal data to generate a two-dimensional traffic signal matrix.

12. The system of claim 11, wherein:
the memory further stores a deep learning module; and
the instructions, when executed by the processing device, further cause the system to:
provide the temporal detector scan image as input to the deep learning module; and
process the temporal detector scan image using the deep learning module to generate traffic signal control data.

13. The system of claim 12, wherein:
the deep learning module comprises a deep reinforcement learning module;
processing the temporal detector scan image comprises using the deep reinforcement learning module to generate traffic signal control data by applying a policy to the temporal detector scan image; and
the instructions, when executed by the processing device, further cause the system to:
determine an updated state of the traffic environment following application of the traffic signal control data to the traffic signal;
generate an updated temporal detector scan image based on the updated state of the traffic environment;
generate a reward by applying a reward function to the temporal detector scan image and the updated temporal detector scan image; and
adjust the policy based on the reward.

14. The system of claim 13, wherein:
the deep reinforcement learning module comprises a deep Q network; and
the traffic signal control data comprises a decision between:
extending a current phase of a cycle of the traffic signal; and
advancing to a next phase of the cycle of the traffic signal.

15. The system of claim 13, wherein:
the deep reinforcement learning module comprises a proximal policy optimization (PPO) module; and
the traffic signal control data comprises a phase duration for at least one phase of a cycle of the traffic signal.

16. The system of claim 11, wherein the instructions, when executed by the processing device, further cause the system to, for each location of the first locations and second locations:
obtain point detector data for the location; and
generate the traffic state data based on the point detector data for each location.

17. The system of claim 16, further comprising, for each location of the first locations and second locations, a point detector configured to generate the point detector data based on sensed vehicle traffic at the location.

18. The system of claim 17, wherein each point detector comprises an inductive-loop traffic detector.

19. The system of claim 17, wherein each point detector comprises a point camera.

20. A processor-readable medium having machine-executable instructions stored thereon which, when executed by a processor device, cause the processor device to perform the method of claim 1.
